(19) United States
(12) Patent Application Publication
(10) Pub. No.: US 2014/0220622 A1
(43) Pub. Date: Aug. 7, 2014

(54) DIGITAL HOLOGRAPHIC MICROSCOPY APPARATUS AND METHOD FOR CLINICAL DIAGNOSTIC HEMATOLOGY

(71) Applicant: WET Labs, Inc., Philomath, OR (US)

(72) Inventors: Michael Stewart TWARDOWSKI, Carolina, RI (US); James Michael SULLIVAN, Peace Dale, RI (US)

(73) Assignee: WET LABS, INC., Philomath, OR (US)

(21) Appl. No.: 14/172,162

(22) Filed: Feb. 4, 2014

Related U.S. Application Data
(60) Provisional application No. 61/760,793, filed on Feb. 5, 2013.

(51) Int. Cl. G01N 21/45

(52) U.S. Cl. CPC G01N 21/453
USPC 435/39; 435/288.7

(57) ABSTRACT

An apparatus, method, and apparatus for hematology analysis comprising using a holographic microscope, in one embodiment a transmission-type holographic microscope. In one aspect, laser light is provided and split into first and second sample beams, the first sample beam for imaging with a first magnification, the second sample beam for imaging with a second magnification. The first and second sample beams are passed through a sample volume requiring hematology analysis. The first and second sample beams are combined with a reference beam and captured for digital analysis. The present invention enables adequate blood cell type differentials with a single, easily implemented, cost-effective holographic technique.

### CROSS-REFERENCE TO RELATED PATENT APPLICATION

This application claims priority from U.S. provisional patent application Ser. No. 61/760,793, filed Feb. 5, 2013, and entitled “Digital Holographic Apparatus and Method for Clinical Diagnostic Hematology,” which is hereby incorporated herein by reference in its entirety.

### TECHNICAL FIELD

This invention relates in general to digital holographic microscopy for clinical diagnostic hematology.

### BACKGROUND OF THE INVENTION

Digital holographic microscopy (DHM) can provide non-intrusive, non-destructive, high-resolution, instantaneous 3-D imaging of particles at a resolution and sample volume size that few instruments can currently achieve. Recent advancements in lasers, CCD cameras and computing power have substantially reduced the cost, size and complexity of developing holographic analytical systems, rendering it an attractive option for enhanced particle characterization for a wide range of potential applications.

Clinical diagnostic hematology applications such as resolving complete blood count (CBC) parameters are a significant market. The primary advantages of a potential holographic microscopy system over existing CBC devices are functionality and price point. Because an image is collected of each particle in solution, real-time automated shape analysis can discriminate between particles that are approximately the same size. CBC devices employing electroresistive methods can only discriminate with respect to individual particle volume. Diagnostic tests with additional measurement techniques are required to differentiate particles of similar volume.

Using holography, a technician could also interactively investigate the images used in the CBC analysis to identify abnormal cells and assess potential problems such as clumping. Separate microscopic examination with blood smears would not be required. The additional functionality of shape differentiation with holographic microscopy can be achieved with similar accuracy to current automated multi-channel CBC devices. The holographic system, however, could be simpler and more cost effective, with an estimated price point lower than current complex multi-channel BC systems.

Commercial holographic microscope systems are just beginning to reach the market for cellular and tissue studies in the laboratory. Considering the dramatic technical advances being made in lasers, camera systems, and computer processing speed, DHM in the next 5 to 10 years could start to replace current electroresistive methods that have dominated the market since the 1960s.

Current technologies for routine clinical hematology analyses (i.e., complete blood counts or CBCs) also include manual counting by a medical technician with a light microscope and various types of automated analysis systems. The vast majority of CBCs are carried out with automated systems, although about 30% of CBCs are also performed manually to assess the presence of abnormal white blood cells, the degree of clumping in the sample, and to examine the shape of red blood cells (RBCs) as a diagnostic tool. Some normal patients' platelets will clump in EDTA anticoagulated blood, which causes automatic analyses to give a falsely low platelet count. Platelet clumps may be misclassified as leukocytes or erythrocytes, and nucleated red blood cells can be misclassified as leukocytes or, specifically, lymphocytes. The technician viewing the slide in these cases will see, for example, clumps of platelets and is able to then better estimate approximate numbers of platelets. Also, if results from an automated system are irregular, then typically a manual CBC is performed. Manual counting can, however, be subjective, labor-intensive, and statistically unreliable (only 100-200 cells are counted as opposed to thousands with automated counters). It takes experience to consistently make technically adequate smears and, even then, non-uniform distributions of white blood cells (WBCs) and RBCs over the smear create biases.

Besides reducing bias and improving statistical reliability, automated systems dramatically increase sample processing rates and cost-effectiveness.

One primary technique for automated CBC analyses is the impedance or electroresistive method developed by Coulter. Volumes of individual particles passing through an electrically charged orifice can be determined by the change in impedance across the orifice. Up to 23 different diagnostic blood cell parameters can be determined with this measurement for CBC analyses, including red blood cells, mean corpuscular volume, hematocrit, platelets, and white blood cells including granulocytes, monocytes, and lymphocytes. Cell type differentiation with impedance analyzers is carried out exclusively based on individual particle volume, i.e., particle size. Devices employing this method are rapid (<1 min), objective, produce statistically significant results (8000 or more cells are counted per sample), and are not subject to the distributional bias of the manual count. Accuracy in cell counts is directly determined by the number of cells counted. Some of these systems can process more than 120 samples per hour. As mentioned, certain drawbacks of impedance counting can include clumping artifacts and the inability to distinguish between different cell types that are about the same size. For characterization of WBCs at the level of the standard “5-part differential” comprised by the five subpopulations neutrophils, eosinophils, basophils, monocytes and lymphocytes, additional automated measurements are required or a manual count must be performed.

Additional automated differential measurements include radio frequency conductance and angular light scattering to differentiate with respect to shape between closely related WBCs. There are also image analysis systems using morphometric (shape) and densito-metric programs to distinguish cells which are photographed from a stained slide by a digital color camera. When the electronic WBC count is abnormal or a cell population is flagged, meaning that one or more of the results is atypical, a manual differential is performed. Current trends include attempts to incorporate as many analysis parameters as possible into one instrument platform, in order to minimize the need to run a single sample on multiple instruments. Adding automated functionality to differentiate cell types of similar size and volume increases the cost of the system.

An inexpensive (˜$5,000) device on the market for cell counting, but not for complete clinical CBC analyses, is the Countess Counter by Invitrogen. Cells in the 5 to 60 μm range are counted using light microscopy optics by counting cells with automated image analysis software from recorded digital images. Samples are prepared with disposal slides, which can be a substantial added expense over time. Multiple frames on the slide sometimes are necessary to obtain statistically meaningful concentrations. Counts are less accurate than impedance methods and concentrations are rounded to the nearest 100,000 per mL. This system is also much less versatile than the impedance method in types and size of cells that may be counted.

What is required, therefore is a more powerful, easily implemented, lower cost technique for resolving blood cell type differentials.

### SUMMARY OF THE INVENTION

The shortcomings of the prior art are overcome and additional advantages are provided through the present invention which in one aspect is an apparatus, method, and apparatus of hematology analysis comprising using a holographic microscope, in one embodiment a transmission-type holographic microscope.

In one aspect, laser light is provided and split into first and second sample beams, the first sample beam for imaging with a first magnification, the second sample beam for imaging with a second magnification. The first and second sample beams are passed through a sample volume requiring hematology analysis. The first and second sample beams are combined with a reference beam and captured for digital analysis.

The present invention enables adequate blood cell type differentials with a single, easily implemented, cost-effective technique, method, and apparatus.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in combination with the accompanying drawings in which:

FIG. 1 depicts a bench-top in-line DHM system, in accordance with an aspect of the present invention;

FIG. 2 depicts Particle size distribution (PSD) comparison between a bench top DHM, Cytosub flow cytometer and a Beckman Coulter counter;

FIGS. 3a-c depict various holograms;

FIG. 4 is a schematic view of a dual-path holographic microscope system for CBC hematology analyses, in accordance with an aspect of the present invention;

FIGS. 5a-b include a splat image and corresponding intensity chart of 3-D hologram taken with 2.5× objective of whole blood; and

FIG. 6 includes sketches of 6 white blood cell types.

### DETAILED DESCRIPTION OF THE INVENTION

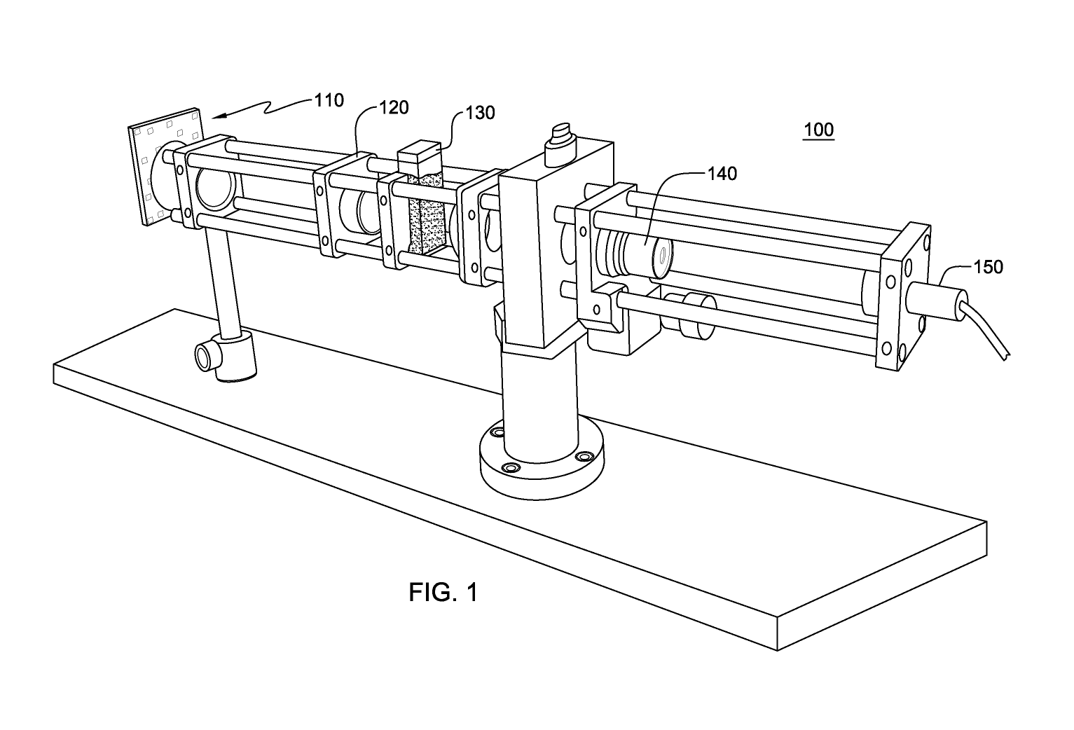

Transmission holographic imaging generically refers to recording the interference pattern of a reference beam with light that has been diffracted by particles in a suspension. When reconstructed, the result is a 3-D image of all the particles in the sample volume, all simultaneously in focus. There are a number of different optical arrangements for a holographic microscope, each having different advantages and disadvantages. The simplest optical setup, which is particularly suitable for characterizing small particles, is in-line holography. In this method, a collimated light source, typically from a laser, enters the sample. The diffraction pattern generated by the particle suspension is recorded along with the reference beam, which consists of that portion of the incident light that was not scattered. No separate optical path for the reference beam is needed. Placing a microscope objective in-line after the sample, a digital CCD camera can be used to record the magnified interference image on the other side of the sample volume. This is a referred to as an in-line Digital Holographic Microscope (DHM) system 100 as shown in FIG. 1. From left to right, the components are a CCD high resolution board camera 110, a microscope objective 120, sample holder with cuvette 130, a spatial filter assembly 140, and a small CW laser 150. Each image is a 3-D rendering of every particle between 2 and 2000 μm, in size in a sample volume of 500 μL. Cost of the entire system is about $1000. A spatial filter can be added to reduce optical aberrations from the source laser. Each frame collected by the camera is an individual hologram. One of the advantages of holographic microscopy over conventional light microscopy is that the plane of focus (i.e., the effective sample volume) is up to 3 orders of magnitude greater, allowing substantially more particles to be instantaneously resolved. Statistical accuracy in cell counting is directly a function of the number of cells counted.

To reproduce the 3-D image of the particles from holograms, the laser wave front can be numerically reconstructed plane by plane. The ability to optically section holograms into image planes during reconstruction allows the extraction of individual particle characteristics (e.g. size, shape, volume, number, cross-sectional area, surface area, aspect ratio, sphericity, etc.), their 3-D spatial distribution (e.g. nearest neighbor distances), orientation, and 4-D motion (in short pulsed serial holograms). Shape recognition algorithms allow discrimination of different types of particles that may be of similar diameter and volume. The assignee of the present invention has developed a dual path submersible DHM system (called the HOLOCAM) capable of non-intrusively characterizing these properties for particles found in the ocean within a size range of <1 to 1000 μm.

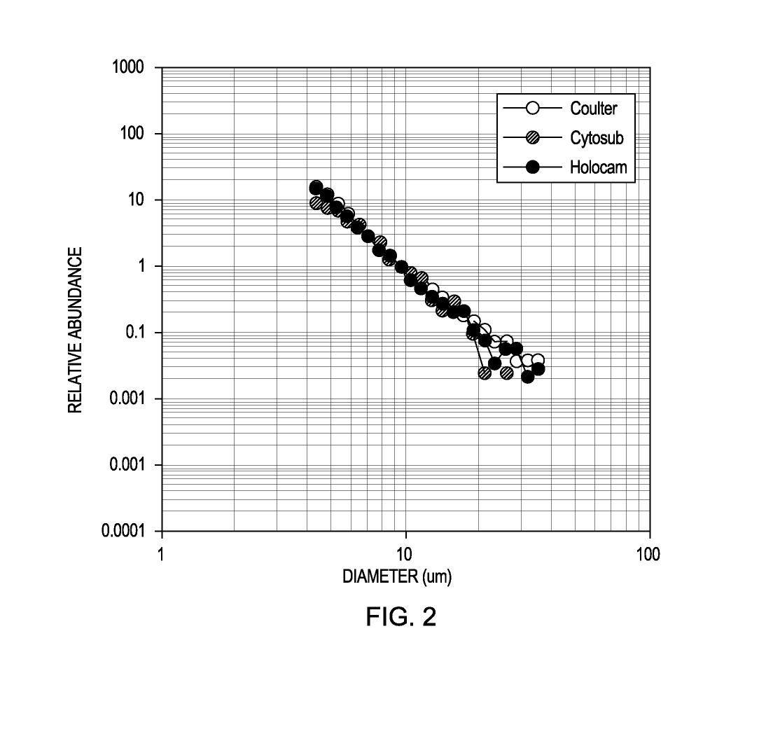

DHM systems provide particle size distributions with equivalent accuracy to BC electroresistive-based devices and flow cytometers (FIG. 2). FIG. 2 shows a particle size distribution (PSD) comparison between a bench top DHM, Cytosub flow cytometer and a Beckman Coulter counter. The particle standard Arizona Test Dust (PTI, Fine) is used in the analysis. The bench top DHM was optimized for particle sizes>4 to 5 μm and the Cytosub for particles>2 μm. The PSDs compare extremely well within the working measurement ranges of these devices.

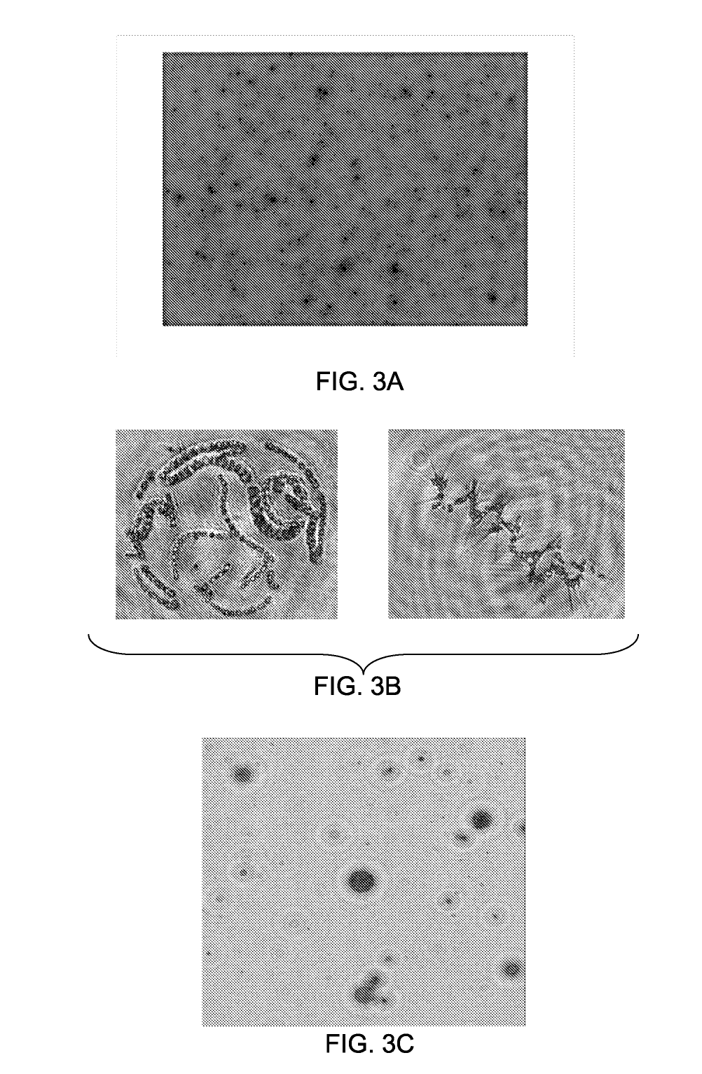

However, a DHM system can provide a greater level of particle characterization information, with results in near-real time. In accordance with the present invention, DHM can provide the CBC multi-parameter analysis of an expensive (>$100K) multi-channel system including differentiation of WBCs and mature and immature RBCs, but at a much lower cost. Holograms contain actual particle images (FIGS. 3a-c), thus enabling automated higher level analytical discrimination based on characteristics such as shape, orientation, motion etc. Shown in FIGS. 3a-c are 3a) reconstructed “splat” hologram (all particles in 3-D volume compressed into a single 2-D plane) of the particle standard used in FIG. 2 analysis; 3b) holograms of spherical and spiral colonial phytoplankton from the ocean; and 3c) splat hologram of an oil emulsion. Good automated shape recognition algorithms exist, and with this application there is the added benefit of an a priori very well-defined particle field to fine tune such algorithms. Holography systems can be adapted to “free-stream” applications (undisturbed sampling of particles in a remote volume of solution), flow-through systems, and static sampling in bench-top configurations. Sampling rate can be high and is a function of the frame rate of the CCD camera used in the system (cameras typically output at 6 or 15 frames per second).

DHM can also enable more rapid manual analysis of CBC parameters when required. If a problem is flagged in automated analysis (much like current BC systems), then a manual analysis can be carried out directly with the same system using the same holographic image used in the automated analysis. The technician could manually investigate particles in the image and would not need to prepare an entirely new blood smear for separate microscopic analysis. 3-D holographic imaging devices thus have the potential to combine several disparate measurements or actions for CBC analyses into a single platform with less expensive technology.

Nearly all transmissive DHM systems employ a form factor analogous to the conventional light microscope (Marquet et al. 2005; Rappaz et al. 2008; Alm et al 2011; Liu et al. 2011; Mihailescu et al. 2011). The sample must be put in a sample chamber around 1 mm thick that is positioned horizontally relative to a vertically impinging light path. Reflective DHM systems also employ this general form factor. The primary advantage these DHM systems have over a classic inverted light microscope is topographical quantitation of cells and tissues, i.e., a quantitative 3-D image can be constructed of the specimen. The potential 2-3 order improvement in depth of field does not appear to be a significant selling factor. They are useful for scientific studies in cellular biology but in their current configuration would generally not be suitable for diagnostic hematology applications that currently employ standard BC counters. For some applications, the samples also need to incubate at 37 deg C for 20-30 min so that the cells adhere to the cover slip. This indicates that cell movement is undesirable, probably because of blurring.

Table 1 lists the cells in blood requiring quantification in a CBC, with sizes ranging between approximately 2 μm and 20 μm. A standard quality CCD array camera such as the 8-bit monochrome USB-powered options from Mightex have a 2592×1944 pixels array size, pixel size of 4.4 μm, and image size of 10×10 mm². To accurately image particles as small as 2 μm, a 10× objective would be required. This would result in an image size of 1×1 mm² with a depth of field of approximately 5 mm, providing a sample volume of 5 μL. The number of cells to be counted in whole blood of that volume is on the order of 26.5×10⁶ cells. For in-line holography systems (where the reference beam passes directly through the sample volume), degradation of the beam starts to occur at concentrations of about 30,000 particles per image. Thus, sample dilution is required, as is the case with typical impedance counters.

TABLE 1
Typical concentrations of cell types in blood.

| | | normal | normal | normal |
|---|---|---|---|---|
| | size | concentration | concentration | concentration |
| blood cell type: | (μm) | (μL) | (mL) | (L) |
| platelets | 2-3 | 300000 | 3.00E+08 | 3.00E+11 |
| red blood cells | 6-8 | 5000000 | 5.00E+09 | 5.00E+12 |
| white blood | | 3000 | 3.00E+06 | 3.00E+09 |
| cells: | | | | |
| Neutrophils | 12-15 | 1800 | 1.80E+06 | 1.80E+09 |
| Eosinophils | 12-15 | 90 | 9.00E+04 | 9.00E+07 |
| Basophils | 9-10 | 30 | 3.00E+04 | 3.00E+07 |
| Lymphocytes | 8-10 | 900 | 9.00E+05 | 9.00E+08 |
| Monocytes | 16-20 | 165 | 1.65E+05 | 1.65E+08 |
| Total | | 5303000 | 5.30E+09 | 5.30E+12 |

TABLE 2
Typical concentrations of cell types in 5 μL volume diluted blood.

| | | normal | 1000X | 500X |
|---|---|---|---|---|
| | | concentration | dilution | dilution |
| blood cell type: | size (μm) | (μL) | 5 μL | 5 μL |
| platelets | 2-3 | 300000 | 1500 | 3000 |
| red blood cells | 6-8 | 5000000 | 25000 | 50000 |
| white blood cells: | | 3000 | 15 | 30 |
| Neutrophils | 12-15 | 1800 | 9 | 18 |
| Eosinophils | 12-15 | 90 | 0.45 | 0.9 |
| Basophils | 9-10 | 30 | 0.15 | 0.3 |
| Lymphocytes | 8-10 | 900 | 4.5 | 9 |
| Monocytes | 16-20 | 165 | 0.825 | 1.65 |

TABLE 3
Typical concentrations of cell types in 160 μL volume diluted blood.

| | | normal | 1000X | 500X |
|---|---|---|---|---|
| | | concentration | dilution | dilution |
| blood cell type: | size (μm) | (μL) | 160 μL | 160 μL |
| platelets | 2-3 | 300000 | 48000 | 96000 |
| red blood cells | 6-8 | 5000000 | 800000 | 1600000 |
| white blood cells: | | 3000 | 480 | 960 |
| Neutrophils | 12-15 | 1800 | 288 | 576 |
| Eosinophils | 12-15 | 90 | 15 | 29 |
| Basophils | 9-10 | 30 | 5 | 10 |
| Lymphocytes | 8-10 | 900 | 144 | 288 |
| Monocytes | 16-20 | 165 | 26 | 53 |

Approximate cell numbers with 500× and 1000× dilutions are provided in Table 2. Imaging higher concentrations of particles is also possible by splitting off the reference beam so that it does not pass through the sample volume. It is clear from Table 2 that counting RBCs and platelets with a 10× objective would be straightforward after dilution. Numbers of white blood cells, however, would be too low to statistically provide adequate cell count resolution.

There are two options to accurately resolve the WBCs: 1) lyse the RBCs and centrifuge the sample to concentrate the WBCs (as is currently done for impedance counters), or 2) use a lower magnification path to image the larger WBCs. The second option is readily achieved with a second beam path and provides a solution requiring less sample processing time and reagents. A 2× objective would be able to image cells greater than about 8 μm, resulting in an image size of 4×4 mm², a depth of field of 10 mm, and a subsequent sample volume of 160 μL. Approximate cell numbers with 500× and 1000× dilutions for this sample volume are provided in Table 3. Most WBC types could be counted with reasonable statistics with this approach. Lower dilutions would be possible to improve counting statistics for the WBCs. The high number of RBCs and platelets would require the reference beam be split from the sample beam to avoid beam degradation.

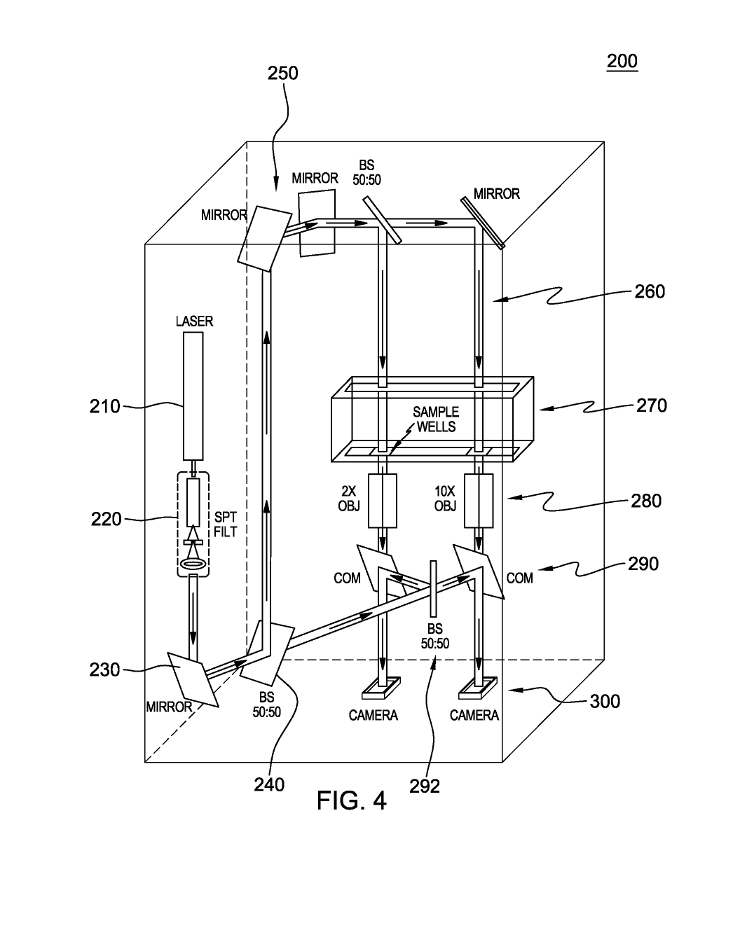

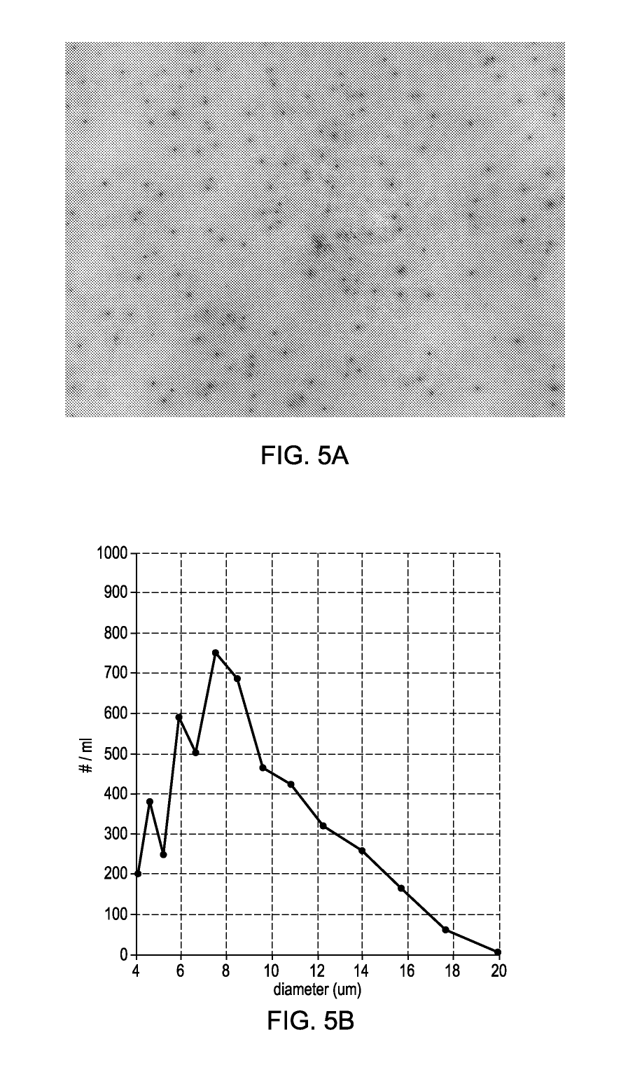

FIG. 4 shows a schematic of a dual-path holographic system for CBC analyses based on the above analysis using an inexpensive laser diode source. In this schematic view of an exemplary dual-path holographic microscope system 200 for CBC hematology analyses, collimated laser light from a laser 210 passes through a spatial filter 220, is folded by a mirror 230, and split into reference and sample beams with a 50:50 beam splitter 240. The sample beam is then folded twice with two mirrors 250, and is split into two sample beams 260, one for imaging with 2× magnification, the other for imaging with 10× magnification. After passing through the sample volumes 270 and respective objectives 280, the beams are recombined 290 with the reference beam that has also passed through a 50:50 beam splitter 292. Recombined sample+reference beams then are imaged onto independent CCD array cameras 300. Blood count results from a similar system on the bench top (see FIG. 1) with a 2.5× objective are shown in FIG. 5, which is a splat image and corresponding intensity chart of a 3-D hologram taken with 2.5× objective of whole blood diluted in saline solution with accompanying size distribution. The strong peak between 6 and 8 μm is due to RBCs.

Approx. market prices of the system optical components shown in FIG. 4 are:

| Item | QTY | Cost |
|---|---|---|
| Laserex LDM-5 low divergence, 5 mW, continuous | 1 | $150 |
| wave, 635 nm laser | | |
| Mightex 5MP 8-bit monochrome CMOS camera, | 2 | $1150 |
| Model BCN-B050-U | | |
| Spatial filter, part # KT310 | 1 | $660 |
| 10X DIN Acromatic Commercial Grade Objective | 1 | $70 |
| 2X DIN Acromatic Commercial Grade Objective | 1 | $70 |
| Mirrors | 4 | $200 |
| Beam splitters, 50:50 | 3 | $600 |
| Beam combiners | 2 | $400 |
| TOTAL | | $3300 |

A housing and mounts would also be needed. The samples could be dispensed into a disposable custom slide with sample wells. A computer with loaded software would be needed to operate the system, collect the images, and process the images. Expected accuracy in cell counts for the proposed dual-path system would be comparable to existing multi-channel automated CBC analyzers. The holographic system, however, would be simpler and more cost effective, with a price point lower than a $100,000 price point for current complex multi-channel systems. Accuracy could perhaps be better with the holographic system since more platelet and RBC cells could be counted in a single image. Cells of similar size but different shape could be autonomously discriminated with images from the dual-path system. Cell clumping and coincidence counting with impedance counters would no longer pose problems. Manual investigation and analysis by a technician could occur with the same images used in the automated size distribution and cell shape analyses without the need for initiating a secondary blood smear with microscope analysis.

The most significant technical challenges involve optimizing the holographic system for deriving highly accurate CBC parameters with as little upfront sample processing as possible. For example, what is the highest concentration of blood cells that can be counted without interference when the reference beam is split to avoid passing through the sample volume? The rule of thumb for particle diffraction patterns is the particles need to be separated by at least 3 times their radii to avoid interference (van de Hulst 1981). For particles the size of RBCs, this means it is theoretically possible to accommodate exceedingly high concentrations, greater than 500,000 cells per μL, but the cells need to maintain sufficient spacing within the sample volume. Even if RBC concentrations of 100,000 cells per μL, could be accommodated, blood dilutions for the low magnification path could be as low as 50×, providing 10 times the cell numbers for white blood cells that were listed under the 500× dilution in Table 3. Such concentrations would provide excellent statistical counting accuracy for all white blood cell types. Research is needed to determine dilution levels for optimal accuracy.

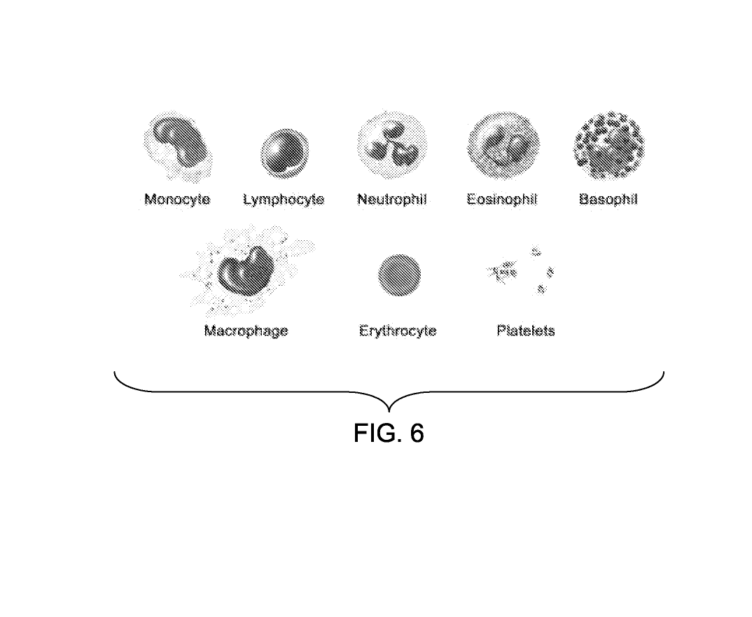

Accurate and consistent can cell type differentiation be accomplished in images of cell diffraction patterns. Sketches of the different cell types are shown in FIG. 6 (Sketches of 6 white blood cell types, a red blood cell (erythrocyte), and platelets). Since multiple angle scattering is currently used to differentiate WBC particle types by shape, it is reasonable to conclude that differences in cell diffraction patterns should be adequate for cell type differentiation.

Software to automate image cell type differentiation analysis can be provided to produce final results in <1 min to the user, including differentiation of particle shapes such as spheres, spheroids, and cylinders. A library of shapes representing cells in blood would can be provided along with a training technique to accurately identify specific particle types.

The following documents are hereby incorporated by reference herein in their entirety.
Alm, K., Helena Cirenajwis, Lennart Gisselsson, Anette Gjörloff Wingren, Birgit Janicke, Anna Molder, Stina Oredsson and Johan Persson (2011). Digital Holography and Cell Studies, In: Holography, Research and Technologies, Joseph Rosen (Ed.), ISBN: 978-953-307-227-2, InTech, Available from: http://www.intechopen.com/articles/show/digital-holography-and-cell-studies
Liu, R., D. Dey, D. Boss, P. Marquet, and B. Javidi (2011). Recognition and classification of red blood cells using digital holographic microscopy and data clustering with discriminant analysis. J. Opt. Soc. Am. A, 28(6), 1204-1210.
Marquet, P., B. Rappaz, P. Magistretti, E. Cuche, Y. Emery, T. Colomb, and C. Depeuringe (2005). Digital holographic microscopy: a noninvasive contrast imaging technique allowing quantitative visualization of living cells with subwavelength axial accuracy. Optics Letters, 30(5), 468-470.
Mihailescu, M., Mihaela Scarlat, Alexandru Gheorghiu, Julia Costescu, Mihai Kusko, Irina Alexandra Paun, and Eugen Scarlat (2011). Automated imaging, identification, and counting of similar cells from digital hologram reconstructions, Appl. Opt., 50, 3589-3597.
Rappaz, B., and OTHERS (2008). Comparative study of human erythrocytes by digital holographic microscopy, confocal microscopy, and impedance volume analyzer. Cytometry, 73A, 895-903.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A hematology analysis apparatus comprising a holographic microscope.

2. The apparatus of claim 1, wherein the holographic microscope comprises a transmission-type holographic microscope.

3. The apparatus of claim 1, wherein the holographic microscope comprises:
a source of laser light;
a beam splitter for splitting the laser light into first and second sample beams, the first sample beam for imaging with a first magnification, the second sample beam for imaging with a second magnification; and
a sample hematology volume requiring analysis through which the first and second sample beams pass.

4. The apparatus of claim 3, wherein the holographic microscope further comprises:
respective combining stages for combining the first and second sample beams and a reference beam; and
at least one capture device for capturing the recombined first and second sample beams.

5. The apparatus of claim 4, further comprising a digital processor for processing the captured, recombined first and second sample beams.

6. A method of hematology analysis comprising using a holographic microscope.

7. The method of claim 6, wherein the holographic microscope comprises a transmission-type holographic microscope.

8. The method of claim 6, further comprising:
providing laser light;
splitting the laser light into first and second sample beams, the first sample beam for imaging with a first magnification, the second sample beam for imaging with a second magnification; and
passing the first and second sample beams through a sample volume requiring hematology analysis.

9. The method of claim 8, further comprising:
combining the first and second sample beams and a reference beam; and
capturing the recombined first and second sample beams.

10. The method of claim 9, processing the captured, recombined first and second sample beams in a digital processor.
